(19) United States
(12) Patent Application Publication
(10) Pub. No.: US 2025/0095001 A1
(43) Pub. Date: Mar. 20, 2025

(54) METHOD AND APPARATUS FOR ELECTRONICALLY READABLE PRODUCT CODE LABELING SYSTEM

(71) Applicants: Marcus Edmonds Estes, Newberg, OR (US); Leif H. Shackelford, Portland, OR (US)

(72) Inventors: Marcus Edmonds Estes, Newberg, OR (US); Leif H. Shackelford, Portland, OR (US)

(21) Appl. No.: 18/887,303

(22) Filed: Sep. 17, 2024

Related U.S. Application Data
(60) Provisional application No. 63/583,637, filed on Sep. 19, 2023.

(51) Int. Cl. G06Q 30/018; G06K 19/06

(52) U.S. Cl. CPC G06Q 30/0185; G06K 19/06037

(57) ABSTRACT

An electronically readable code system to create a plurality of readable codes. In various examples the codes are QR codes or other printable codes which are electronically readable and which allow the user to create millions of unique electronically readable codes, print or store them on compliant product labels, and encode them with data for supply chain partners as well as consumers. In various embodiments the system creators a database backed electronically readable code system that enables the user to “serialize” an entire packaged goods supply chain. In this way a user can give each individual unit of a product offering its own code and track the manufacturing, distribution, and sales information with a private remote database for every unit of that product offering. The system allows for control of the reading and writing of data for that database to protect the custody of the information for up to each and every unit of the product offering. The system can be used to track the provenance of each individual product unit. Various applications include regulated products, such fruits, vegetables, dairy, meat, cannabis, goods, and services. The system allows for unique per unit tracking of goods and services.

### RELATED APPLICATION

This application claims the benefit of priority under 35 U.S.C. 119 (e) to U.S. Provisional Application Ser. No. 63/583,637, filed on Sep. 19, 2023, the disclosure of which is incorporated by reference in its entirety.

### TECHNICAL FIELD

The present disclosure pertains to methods and apparatus for a track and trace system for products, and more particularly to methods and apparatus for a product identification system providing unique identifier for each unit of a product.

### BACKGROUND

Manufacturers and distributors are accustomed to labeling products with an identifier, such as a bar code having a SKU or other product identifier. Such identifiers are typically applied to every product made by the manufacturer and are fixed for a particular product model. They were designed for fungible product units where individual aspects are not of particular value. However, there are products which are not fungible and these labels do not uniquely identify individual product units, nor can a distributor use them to obtain provenance of the individual product units.

There is a need in the art for an improved labeling system that provides additional information about individual product units. Such a system should be accessible to distributors and vendors and should be updatable with status information for each particular product unit.

### SUMMARY

The present subject matter provides, among other things, a track and trace system combined with a protocol for creating product labels and tracking barcodes across multiple vendors within a supply chain. In various embodiments the present subject matter provides a continuous or nearly continuous updatable controlled database affording various participants in the supply chain to update or investigate a number of parameters associated with product quality, production, and/or status. In various embodiments, such information may be tracked and monitored on a unit basis for any given product using an electronically readable code. In various embodiments the electronically readable code is a bar code. In various embodiments the electronically readable code is a QR code. In various embodiments the electronically readable code is a wirelessly readable code. Those of skill in the art will appreciate that other codes may be used, and may be used in various combinations and subcombinations, without departing from the scope of the present subject matter.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1 is a block diagram of various functional modules of a labeling system according to one embodiment of the present subject matter.

FIG. 2 shows an exemplary labeling schema according to one embodiment of the present subject matter.

FIG. 3 illustrates an example embodiment of a method for labelling product on a per unit basis, according to one embodiment of the present subject matter.

FIG. 4 is a block diagram of various participants in the labeling system according to one embodiment of the present subject matter.

FIG. 5 is a block diagram of a machine in the example form of a computing system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

In various embodiments, the present subject matter provides, among other things, a track and trace system combined with a protocol for creating product labels and tracking barcodes across multiple vendors within a supply chain. The present subject matter may provide a continuously or periodically updatable controlled database affording various participants in the supply chain to update and/or investigate a number of parameters associated with product quality, production, and/or status. Such information may be tracked and monitored on a product unit basis for any given product using an electronically readable code. In various embodiments the electronically readable code is a bar code. In various embodiments the electronically readable code is a QR code. In various embodiments the electronically readable code is a wirelessly readable code. Those of skill in the art will appreciate that other codes may be used, and may be used in various combinations and subcombinations, without departing from the scope of the present subject matter. The examples provided in this disclosure shall reference a QR code as an example, but the disclosure is not limited to QR codes and may include other codes.

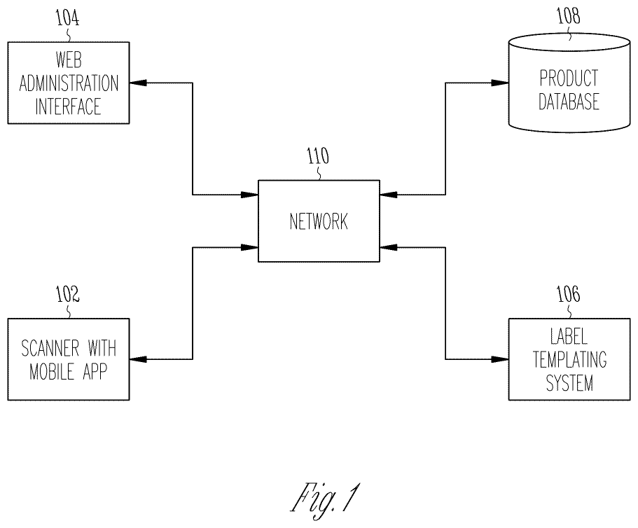

FIG. 1 is a block diagram of various functional modules of a labeling system according to one embodiment of the present subject matter, including the following components:
a. A mobile software application (“mobile app”) 102 that allows users to scan an electronically readable code, such as a bar code, QR code, or other wirelessly readable code to access supply chain provenance information and verify product safety.
b. A web administration interface 104 that manages supply chain data, product data, and customer data.
c. A label templating system 106 that synchronizes compliance data with print or other visual depiction systems.
d. A product database 108, which associates each unit of a product with a unique electronically readable code, such as a bar code, QR code, or other wirelessly readable code and supply chain provenance information for each product unit.

These different components can be located on a single device, multiple devices in one location, or multiple objects in various locations. A network 110 may be used to interconnect any two or more of these modules. In the case of remote devices, the network 110 may be a local area network (LAN), the INTERNET, a personal area network, a wireless network, other networks, or any combination of these networks.

The present subject matter is designed to increase supply chain efficiency while helping consumers make more informed decisions about the products they purchase. The present system may be deployed in a variety of different businesses and applications. One such deployment is in the cannabis retail business. It is understood that cannabis production, distribution and retail is only one application of the present subject matter and that the present subject matter can be deployed in other markets and industries without departing from the scope of the present subject matter.

Cannabis retailers currently expend countless hours re-labeling individual unit packages and manually entering compliance and point of sale data. What is needed in the art is a system for cannabis manufacturers to assist with labeling and data transfer, but without the entailed labor costs. In various embodiments the present subject matter establishes partnership opportunities between supply chain trading partners by allowing them to asynchronously pass messages via a QR-backed shared database.

The present subject matter includes an electronically readable code system to create a plurality of readable codes. In various embodiments the codes are QR codes or other printable codes which are electronically readable and which allow the user to create millions of unique electronically readable codes, print or store them on compliant product labels, and encode them with data for supply chain partners as well as consumers. In various embodiments the system creators a database backed electronically readable code system that enables the user to “serialize” an entire packaged goods supply chain. In this way a user can give each individual unit of a product offering its own code and track the manufacturing, distribution, and sales information with a private remote database for every unit of that product offering. The system allows for control of the reading and writing of data for that database to protect the custody of the information for up to each and every unit of the product offering.

### Barcode Serialization and Product Labeling

Product serialization is the process of assigning globally unique identifiers to individual products within a supply chain. In various embodiments, the present system creates a registry of these unique identifiers and stores them securely in a database 108. The following examples demonstrate the system using the example of QR codes; however, it is understood that any other electronically readable code may be used including, but not limited to, holographic codes, QR codes, barcodes, and RFID codes.

Product manufacturers use the barcode labeling software application to affix a series of these globally unique identifiers to their products via product labeling software. In various embodiments, some examples of this software will perform one or more of the following:
Assign a series of these identifiers to a manufacturing run;
Encode the identifiers into a machine-readable QR code format; and
Provide printable label templates containing these serialized QR codes.

### Permissioned Read and Write

A QR code created by this system will generate mobile-compatible links that lead consumers to a mobile app that will help them learn more about the product. Other users may submit barcodes to a web service Application Programming Interface (API) to attempt to read or write additional data that may not be visible to consumers. The software may provide limited and controlled access to database 108 to provide the ability to update provenance concerning one or more product units, and to read provenance information. A web application manages data read and write permissions for these barcodes. Software administrators may create permission sets for data reads and data writes on a per user, per organization, per barcode, and per barcode batch basis.

Acceptable data writes are managed by a data schema that is attached to the barcode batch. If a permissioned user writes data conforming to this schema “into” the barcode, via API, that data is stored in a database and made available to other permissioned users in the supply chain.

### Case Pack Labeling

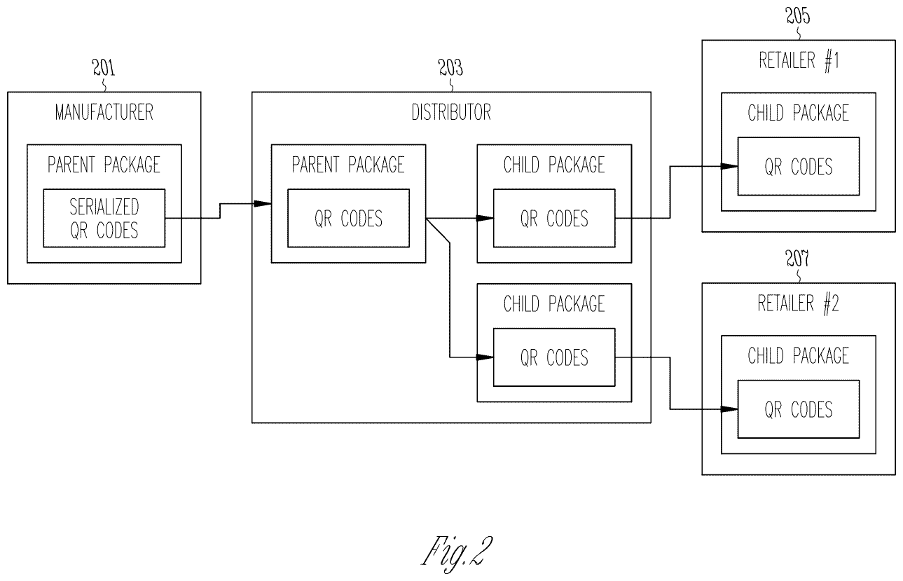

FIG. 2 shows an exemplary labeling schema according to one embodiment of the present subject matter. The manufacturer 201 provides serialized codes (such as a QR code) to a parent package. Distributor 203 can divide the parent package into a plurality of child packages, each having its own unique code (for example, QR codes). Various retailers 205 and 207 receive the various child packages and have access to the code printed on each package to be able to obtain provenance information per product unit and to track sale of each child package.

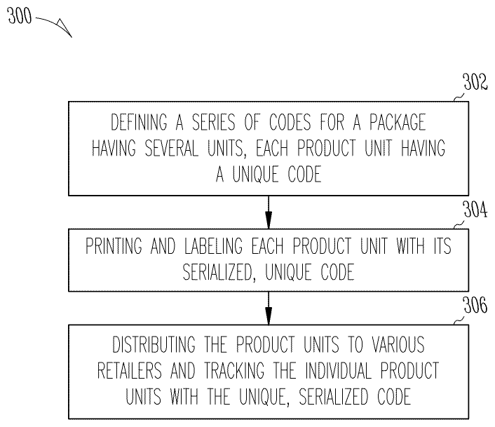

FIG. 3 illustrates an example embodiment of a method for labelling product on a per unit basis, according to one embodiment of the present subject matter. The product is provided with a series of codes; a unique code for each product unit 302. Labels with the codes are printed and applied to the individual product units 304. The unique codes are used to track the shipment and sales of products 306. These codes can also be used to retrieve and/or update provenance for each individual product unit.

Now that each cannabis product has been uniquely labeled with a specific QR code, a label applied to the case pack makes it easy to use an a QR-scanner to load the comprehensive list of units into inventory management systems, as well as downstream point of sale systems. The present system allows for a “case pack label” that is provided by a barcode labeling system at the time of product labeling. A QR code printed on that label contains information needed to help downstream supply chain partners access the product data contained within the package.

### Mobile Content Management System

Various embodiments include a Mobile Content Management System (MCMS), which is a web application for creating and managing mobile content linked to the QR code system. The MCMS allows non-technical users to create content that is also data-rich and ready for machine-readable import by downstream Enterprise Resource Planning (ERP) systems, Warehouse Management Systems (WMS), and Point of Sale (PoS) systems.

The content model is based on a card metaphor, which treats discrete content items as a stack of card in a deck. Cards can represent product data, marketing data, or more data-intensive supply chain certification data. Once a card is created on the system, it can be re-used by being inserted into one or more “stacks” representing production batches.

Content may be created by multiple permission users on the system, belonging to one or more business organizations.

### Streamlined Inventory Receiving

Product labeling and relabeling incur substantial labor costs in modern retail supply chains. Many retail supply chains require their products to be labeled with a barcode generated by their point-of-sale system to allow the cashier to easily locate the product in the POS database and complete a sales transaction.

Products that have been labeled with an individual, unique (and potentially serialized) barcode allow the retailer to skip this secondary labeling process by automating inventory receiving and providing the cashier with a manufacturer-applied barcode that can be used at checkout, rather than a time-consuming retailer-applied secondary label.

To achieve this, retailers use the QR codes affixed to the case pack or individual product package to ingest items into the POS system upon receiving them. Using a compatible POS system, the retail software fetches the following permissioned data from the system's API:
Product metadata, including all SKU-associated data needed to mark the item for sale, and
A list of all unique identifiers assigned to the manufacturing batch.

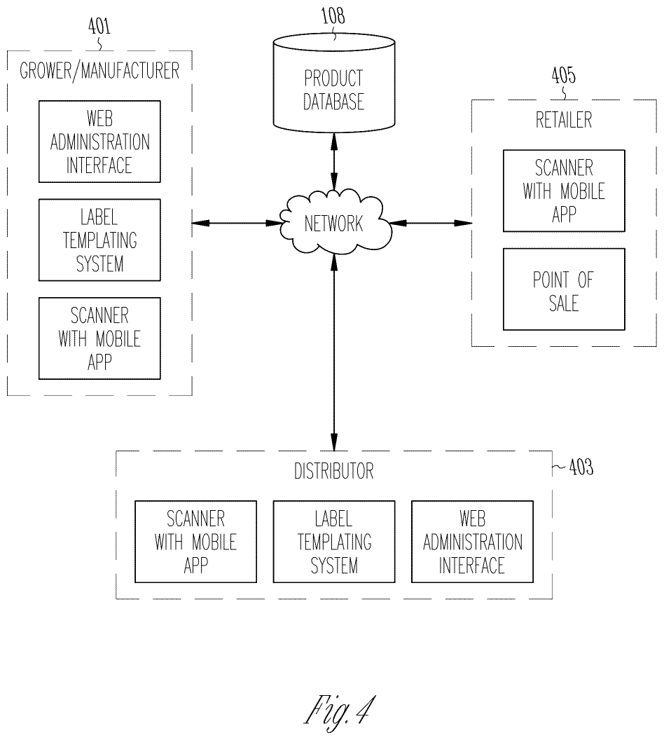

FIG. 4 is a block diagram of various participants in the labeling system according to one embodiment of the present subject matter. The manufacturer (or grower, in the case of plant based products) 401 has a web administration interface and a label templating system to assign specific codes and to generate new codes as needed. These modules communicate with printers (not shown) and a scanner to scan products which have been labeled. The information is stored in the product database 108 which may be hosted on site at the manufacturer 401, or at a remote site, or at multiple sites. The network may be a local network as set forth above, or may be the INTERNET depending on where the information is stored. The distributor 403 can scan product codes as needed to track inventory. The distributor 403 may be able to separate packages containing individual units and to generate new unique codes according to the label templating system so as to identify individual product units and to communicate with database 108. The distributor 403 may also have a web interface to communicate with the product database 108, manufacturer 401, and retailer 405. The retailer has its own scanner and point of sale equipment which can be further used to communicate with database 108 for tracing and tracking of individual product units.

At this moment during the inventory receiving process, the retailer has been sent a known quantity of products, but the products' unique identifiers are unknown to the POS system. The present method prevents manufacturers and distributors from having to invest labor in identifying which UIDs (unique identifiers) are being sent to which retailer out of any given batch. Instead, during inventory the receiving process, the system uses a single UID to alert the PoS system which manufacturing batch the case pack belongs to. The system then returns a complete list of UIDs that belong to the batch. These identifiers are added to a lookup table in the PoS system. After adding any additional needed metadata to the received invoice, the products are then ready to be sold.

Upon checkout, a cashier scans the QR code and references the previously created lookup table. Upon locating a match, the system then completes the checkout process. Finally, the POS then sends the globally unique identifier to the system's API service to validate that it has been sold.

### Anti-Counterfeit Protection

The process of associating globally unique identifiers to products within a supply chain also provides strong protection against counterfeits. Anti-counterfeit protection is enabled by registering a GPS-located data point with every consumer QR scan. The system uses an statistical risk analysis model to determine the risk of a given product being counterfeit. Because each product is uniquely identified via serialized QR, and these QR values are not predictable, product counterfeiters have only two options:
1) Not include a QR code on the counterfeit product.
2) Attempt to copy a QR code already in existence.

If consumers can be educated to expect a QR code that links to an authorized mobile experience on their products, the absence of a QR code will serve as anti-counterfeit protection.

If the counterfeiter attempts to copy a code already in existence, the system will prevent that code from functioning after detecting multiple scans of a product from disparate geographic locations. Once the statistical model determines that a code has been copied and is causing a single unique code to trigger scans from various locations, the system flags the product as counterfeit. The consumer will optionally be notified of this counterfeit determination via the mobile content linked to the QR.

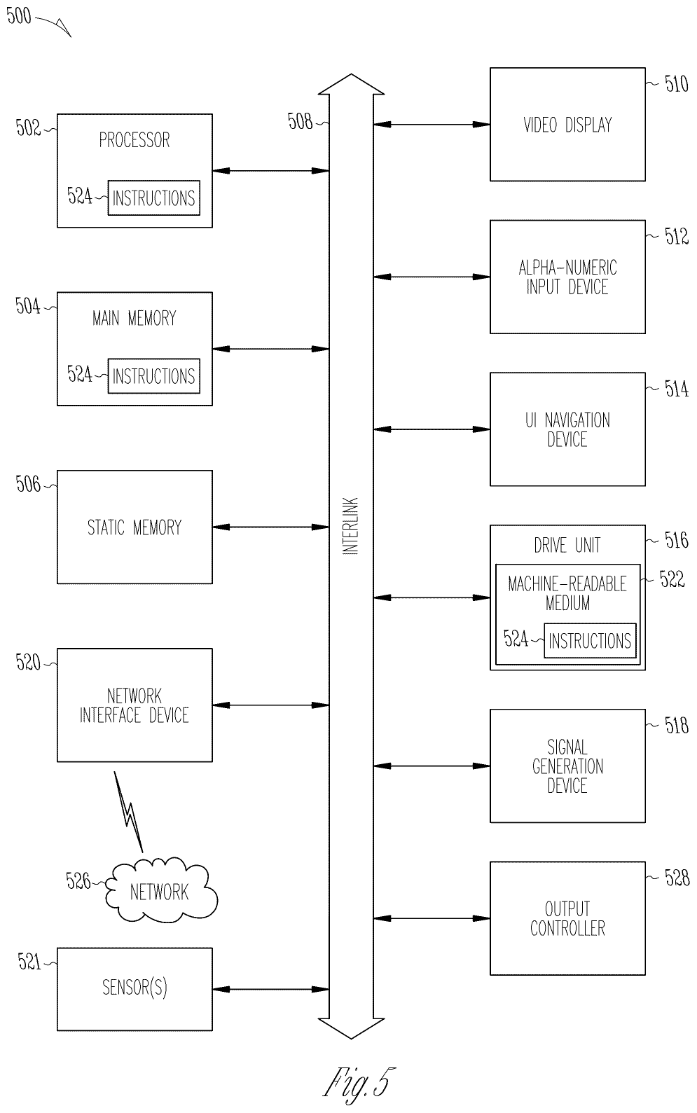

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be configured to perform the method of FIG. 2. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a controller, a microcontroller, a microprocessor, a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, Zigbee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a method for tracking products on a per product unit basis, including associating a unique code to each unit of a plurality of units of a product; storing the unique code in a product database for each unit of the plurality of units; providing a label having the unique code for each unit of the plurality of units, scanning the label of one unit of the plurality of units; and updating information stored in the product database for the one unit.

Example 2 is the method of Example 1 using QR codes.

Example 3 is the method of Example 1 using bar codes.

Example 4 is the method of Example 1 using RFID codes.

Example 5 is the method of any of the foregoing Examples wherein the product includes cannabis.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A method for tracking products on a per product unit basis, comprising:
associating a unique code to each unit of a plurality of units of a product;
storing the unique code in a product database for each unit of the plurality of units;
providing a label having the unique code for each unit of the plurality of units,
scanning the label of one unit of the plurality of units; and
updating information stored in the product database for the one unit.

2. The method of claim 1, wherein the unique code is a QR code.

3. The method of claim 1, wherein the unique code is a bar code.

4. The method of claim 1, wherein the unique code is a RFID code.

5. The method of claim 1, wherein the product comprises cannabis.

6. The method of claim 1, wherein the unique code is a wirelessly readable code.

7. The method of claim 1, further comprising:
providing a case pack label containing information needed to access product data for multiple units within a package.

8. The method of claim 1, further comprising:
registering a GPS-located data point with each consumer scan of the unique code.

9. The method of claim 1, further comprising:
determining a risk of a given product being counterfeit using a statistical risk analysis model based on scan data of the unique code.

10. The method of claim 1, wherein updating information stored in the product database comprises:
managing data read and write permissions for the unique code on a per user, per organization, per code, and per code batch basis.

11. A system using one or more computers for tracking products on a per product unit basis, comprising:
a computer processor;
a memory coupled to the computer processor, the memory storing instructions that, when executed by the computer processor, cause the computer system to perform operations comprising:
associating a serialized code to each unit of a plurality of units of a product;
storing the serialized code in an electronic product database for each unit of the plurality of units;
providing a label having the serialized code for each unit of the plurality of units;
receiving electronic information obtained from an electronic scanner that scanned the label of one unit of the plurality of units; and
updating information stored in the electronic product database for the one unit.

12. The system of claim 11, wherein the serialized code is a QR code.

13. The system of claim 11, wherein the serialized code is a bar code.

14. The system of claim 11, wherein the serialized code is a RFID code.

15. The system of claim 11, wherein the product comprises cannabis.

16. The system of claim 11, wherein the operations further comprise:
providing a case pack label containing information needed to access product data for multiple units within a package.

17. The system of claim 11, wherein the operations further comprise: registering a GPS-located data point with each consumer scan of the serialized code.

18. The system of claim 11, wherein the operations further comprise: determining a risk of a given product being counterfeit using a statistical risk analysis model based on scan data of the serialized code.

19. The system of claim 11, wherein updating information stored in the product database comprises: managing data read and write permissions for the serialized code on a per user, per organization, per code, and per code batch basis.

20. The system of claim 11, wherein the operations further comprise: providing a mobile software application that allows users to scan the serialized code to access supply chain provenance information and verify product safety.
